(19) United States
(12) Patent Application Publication
(10) Pub. No.: US 2024/0193505 A1
(43) Pub. Date: Jun. 13, 2024

(54) EMBEDDED MILESTONE STATUS

(71) Applicant: Rakuten Mobile, Inc., Tokyo (JP)

(72) Inventors: Kuldeep SOLANKI, Madhya Pradesh (IN); Pankaj MUKATI, Madhya Pradesh (IN); Satyam SHRIVASTAV, Madhya Pradesh (IN); Ankush TIWARI, Madhya Pradesh (IN); Vishal JATHOD, Madhya Pradesh (IN)

(21) Appl. No.: 17/904,596

(22) PCT Filed: Jun. 27, 2022
(86) PCT No.: PCT/US2022/035070

§ 371 Date: Aug. 19, 2022

(51) Int. Cl. G06Q 10/0631; G06Q 10/0633

(52) U.S. Cl. CPC G06Q 10/063114; G06Q 10/06316; G06Q 10/0633

(57) ABSTRACT

Embedded milestone status is presented by rendering an interface document to cause a graphical interface to be displayed in accordance with appearance specifications for the graphical interface in the interface document, embedding, into the interface document in response to rendering the interface document, a milestone document corresponding to a reference in the interface document and a user identity, retrieving, through a network in response to embedding the milestone document, a plurality of status values, and indicating, in the graphical interface, each milestone reference among the plurality of milestone references in the sequence that has been completed based on the plurality of status values.

### BACKGROUND

### Technical Field

This description relates to embedded milestone status.

### Background

Coverage of radio access networks is frequently increasing. To increase coverage, new towers and other access points are planned, built, commissioned, etc. Several tasks are involved in adding an access point to a radio access network. These tasks are sometimes distributed among workflows used to manage and track the tasks.

### SUMMARY

According to at least some embodiments of the present invention, embedded milestone status is presented by rendering an interface document to cause a graphical interface to be displayed in accordance with appearance specifications for the graphical interface in the interface document, embedding, into the interface document in response to rendering the interface document, a milestone document corresponding to a reference in the interface document and a user identity, the milestone document including a sequence of a plurality of milestone references, retrieving, through a network in response to embedding the milestone document, a plurality of status values, each status value among the plurality of status values corresponding to a milestone reference among the plurality of milestone references in the milestone document, each status value associated with a task of a workflow for adding a new access point to a radio access network, each workflow stored on a corresponding site database among a plurality of site databases, and indicating, in the graphical interface, each milestone reference among the plurality of milestone references in the sequence that has been completed based on the plurality of status values.

Some embodiments include the instructions in a computer program, the method performed by the processor executing the instructions of the computer program, and an apparatus that performs the method. In some embodiments, the apparatus includes a controller including circuitry configured to perform the operations in the instructions.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a system for embedded milestone status, according to at least some embodiments of the present invention.

FIG. 2 is a communication flow for embedded milestone status, according to at least some embodiments of the present invention.

FIG. 3 is an operational flow for embedded milestone status, according to at least some embodiments of the present invention.

FIG. 4 is a graphical interface with embedded milestone status, according to at least some embodiments of the present invention.

FIG. 5 is an operational flow for milestone template changing, according to at least some embodiments of the present invention.

FIG. 6 is a graphical interface during milestone template changing, according to at least some embodiments of the present invention.

FIG. 7 is an operational flow for milestone template creation, according to at least some embodiments of the present invention.

FIG. 8 is a graphical interface during milestone template creation, according to at least some embodiments of the present invention.

FIG. 9 is a block diagram of a hardware configuration for embedded milestone status, according to at least some embodiments of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

To help track progress of new access points as they are added to a radio access network, graphical interfaces showing completion of tasks are utilized. Because many tasks are involved, the graphical interface only shows a few key tasks, such as milestones. However, different users are interested in different milestones. In such systems, whenever any fixed set-up milestone is needed, or whenever a milestone sequence needs to be re-arranged, development efforts are required each time, for each user.

In at least some embodiments herein, a fully automated system is configured to enable users to define milestones with fields such as name, icon, and color. In at least some embodiments, milestone templates are defined to include any combination of technology, category, site type, etc. for one-time configuration. In at least some embodiments, users draw milestone sequences and configure flow using a drag & drop graphical interface. In at least some embodiments, milestone templates are executed and rendered into the graphical interface in real time. In at least some embodiments, a completion date of each milestone is captured based on runtime. In at least some embodiments, the graphical interface enables users to add custom defined values. In at least some embodiments, milestone templates are created for any combination to reduce every time development efforts to adjust or re-arrange a milestone.

In at least some embodiments, an apparatus enables users to perform a method including creating a milestone master, defining a milestone template with a process flow and a sequence, and mapping a template with a combination of technology, site-type, and category. In at least some embodiments, the apparatus will automatically trigger execution of the template to present a milestone status view.

In at least some embodiments, the milestone information is in a milestone document that is separate from an interface document. In at least some embodiments, the milestone document includes only the information that varies from user to user, and the interface document includes information that is the same for each user, which conserves storage space. In at least some embodiments, the interface document includes API calls for each milestone reference that requests the minimum information necessary to present the milestone reference, which conserves bandwidth and processing power.

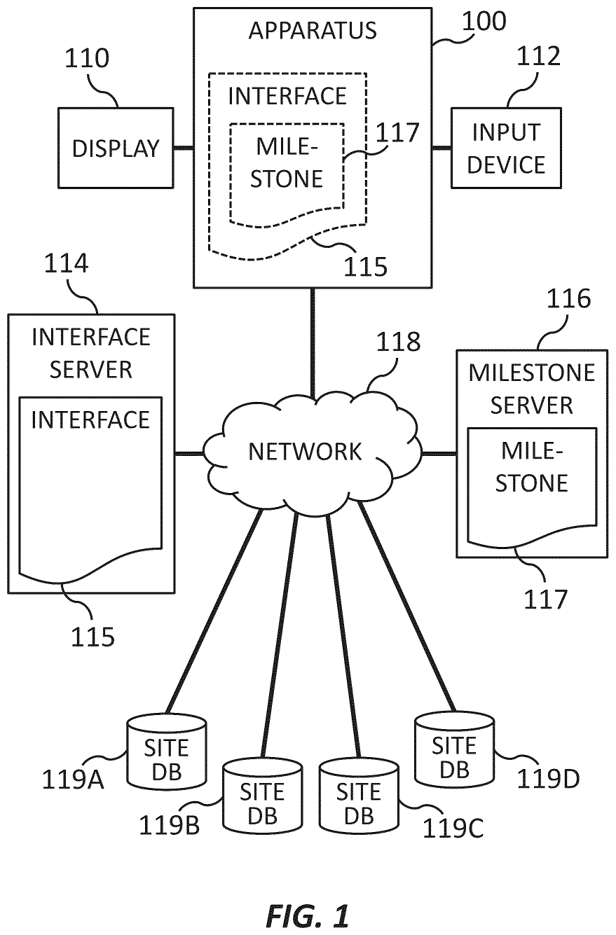

FIG. 1 is a block diagram of a system for embedded milestone status, according to at least some embodiments of the present invention. The system includes an apparatus 100, a display 110, an input device 112, an interface server 114, a milestone server 116, a network 118, and a plurality of site databases 119A, 119B, 119C, and 119D.

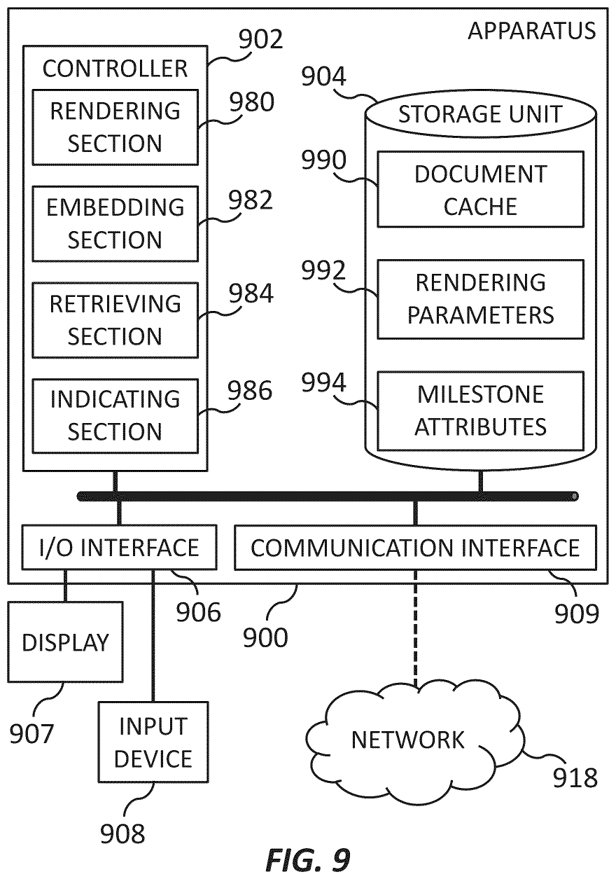

Apparatus 100 receives input signals from input device 112 and transmits output signals to display 110. In at least some embodiments, apparatus 100 is configured for embedded milestone status. In at least some embodiments, apparatus 100 receives an interface document 115 and a milestone document 117, and embeds milestone document 117 into interface document 115. In at least some embodiments, output signals are transmitted to display 110 to present a graphical interface in accordance with interface document 115 and milestone document 117. In at least some embodiments, apparatus 100 includes the structure of apparatus 900 described hereinafter with respect to FIG. 9.

Interface server 114 is in communication with apparatus 100 through network 118. In at least some embodiments, interface server 114 is configured to store interface documents, such as interface document 115. In at least some embodiments, interface document 115 includes an instruction to request a milestone document. In at least some embodiments, interface document 115 includes appearance specifications for the graphical interface. In at least some embodiments, interface document 115 is an HTML (Hyper-Text Markup Language) document. In at least some embodiments, interface document 115 includes a string representing an API call for retrieving the milestone document. In at least some embodiments, the instruction includes a network address of a milestone document, such as milestone document 117. In at least some embodiments, interface server 114 is configured to respond to requests for interface documents by transmitting interface documents to requesting apparatuses through network 118. In at least some embodiments, interface server 114 is an HTTP (Hyper-Text Transfer Protocol) server. In at least some embodiments, interface server 114 is a stand-alone server or a virtual server instance provided on one or more servers of a cloud computing network.

Milestone server 116 is in communication with apparatus 100 through network 118. In at least some embodiments, milestone server 116 is configured to store milestone documents, such as milestone document 117. In at least some embodiments, milestone document 117 includes a plurality of milestone references, each milestone reference including an instruction to retrieve an associated status value from a site database among the plurality of site databases 119A, 119B, 119C, and 119D. In at least some embodiments, the milestone document 117 is a JSON (JavaScript Object Notation) document or an XML (eXtensible Markup Language) document. In at least some embodiments, milestone server 116 is configured to respond to requests for milestone documents by transmitting milestone documents to requesting apparatuses through network 118. In at least some embodiments, milestone server 116 is configured to respond to requests to update milestone documents by receiving milestone documents from apparatuses through network 118. In at least some embodiments, milestone server 116 is an API (Application Programming Interface) server. In at least some embodiments, milestone server 116 is a stand-alone server or a virtual server instance provided on one or more servers of a cloud computing network.

Network 118 is configured to facilitate communication among electronics, such as apparatus 100, interface server 114, milestone server 116, and site databases 119A, 119B, 119C, and 119D. In at least some embodiments, network 118 is a telecommunications network including radio access points and backend servers. In at least some embodiments, network 118 is a wide area network, such as the Internet, that connects many different sub networks. In at least some embodiments, network 118 supports one or more communication standards so that many different types of electronics are able to connect.

Site databases 119A, 119B, 119C, and 119D are each in communication with apparatus 100 through network 118. In at least some embodiments, site databases 119A, 119B, 119C, and 119D are each configured to store resource values for a corresponding resource. In at least some embodiments, site databases 119A, 119B, 119C, and 119D are each configured to store associated information, such as one or more resource value constraints associated with each stored resource value. In at least some embodiments, site databases 119A, 119B, 119C, and 119D are configured to respond to requests for resource values by transmitting resource values to requesting apparatuses through network 118. In at least some embodiments, site databases 119A, 119B, 119C, and 119D are configured to respond to requests to update resource values by receiving resource values from apparatuses or other devices through network 118. In at least some embodiments, site databases 119A, 119B, 119C, and 119D are each an API (Application Programming Interface) server. In at least some embodiments, site databases 119A, 119B, 119C, and 119D are each a stand-alone server or a virtual server instance provided on one or more servers of a cloud computing network.

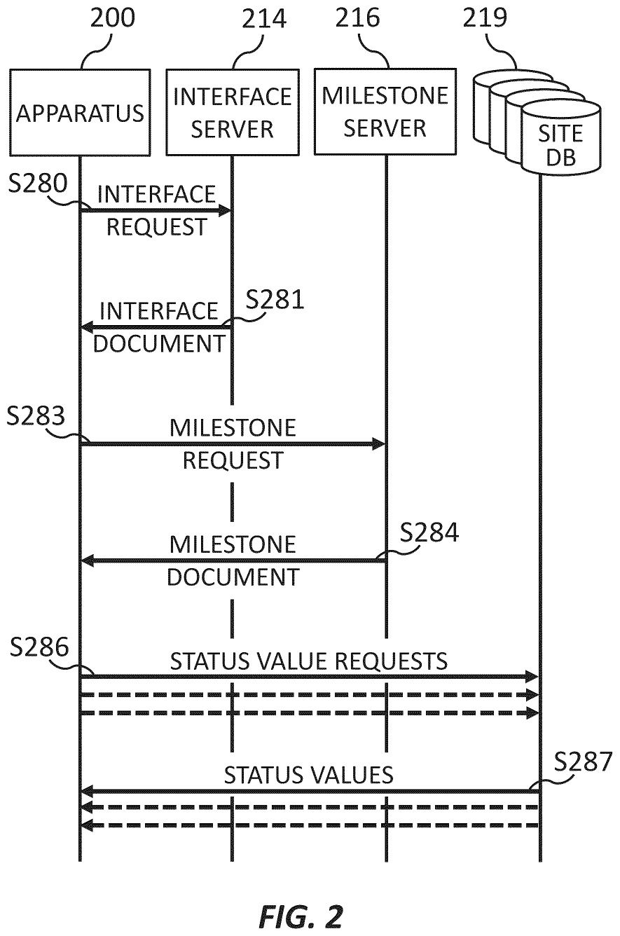

FIG. 2 is a communication flow for embedded milestone status, according to at least some embodiments of the present invention. The communication flow is conducted to perform a process of embedded milestone status. In at least some embodiments, the communication flow is conducted among an apparatus 200, an interface server 214, a milestone server 216, and a plurality of site databases 219.

At S280, apparatus 200 transmits a request for a graphical interface from interface server 214. In at least some embodiments, apparatus 200 provides a browser application for enabling a user to cause apparatus 200 to transmit requests through an input device. In at least some embodiments, apparatus 200 transmits the request through HTTP. In at least some embodiments, apparatus 200 receives input signals from the input device for requesting the graphical interface. In at least some embodiments, the input signals include a network address of an interface document including appearance specifications for the graphical interface. In at least some embodiments, apparatus 200 transmits the request along with a role identifier.

At S281, interface server 214 transmits the requested interface document to apparatus 200. In at least some embodiments, interface server 214 transmits the interface document through HTTP. In at least some embodiments, interface server 214 transmits one interface document among a plurality of interface documents corresponding to the role identifier.

At S283, apparatus 200 transmits a request for a milestone document from milestone server 216. In at least some embodiments, the browser application causes apparatus 200 to transmit the request during rendering of the interface document. In at least some embodiments, apparatus 200 transmits the request through an API. In at least some embodiments, the interface document includes an instruction to request the milestone document. In at least some embodiments, the instruction includes a network address of a milestone document. In at least some embodiments, apparatus 200 transmits the request along with a user identifier.

At S284, milestone server 216 transmits the requested milestone document to apparatus 200. In at least some embodiments, milestone server 216 transmits the milestone document through the API. In at least some embodiments, milestone server 216 transmits one milestone document among a plurality of milestone documents corresponding to the user identifier. In at least some embodiments, milestone server 216 verifies one or more credentials associated with the user identifier, such as a password or biometric, before transmitting the milestone document.

At S286, apparatus 200 transmits a plurality of requests for resource values from the plurality of site databases 219. In at least some embodiments, the browser application causes apparatus 200 to transmit the requests during rendering of the interface document in response to receiving the milestone document. In at least some embodiments, the milestone document includes a plurality of milestone references, each milestone reference including an instruction to retrieve the associated status value from a site database among the plurality of site databases 219. In at least some embodiments, apparatus 200 transmits each request through an API of the corresponding site database. In at least some embodiments, each instruction includes a network address of the corresponding site database among site databases 219. In at least some embodiments, apparatus 200 transmits the request along with a user identifier. In at least some embodiments, apparatus 200 transmits more than one request to the same site database.

At S287, each site database among site databases 219 transmits the requested status value to apparatus 200. In at least some embodiments, each site database among site databases 219 transmits the status value through the API. In at least some embodiments, each site database among site databases 219 verifies whether the user identifier has permission to access the corresponding status value before the transmission. In at least some embodiments, each site database among site databases 219 transmits associated information, such as a status value constraint.

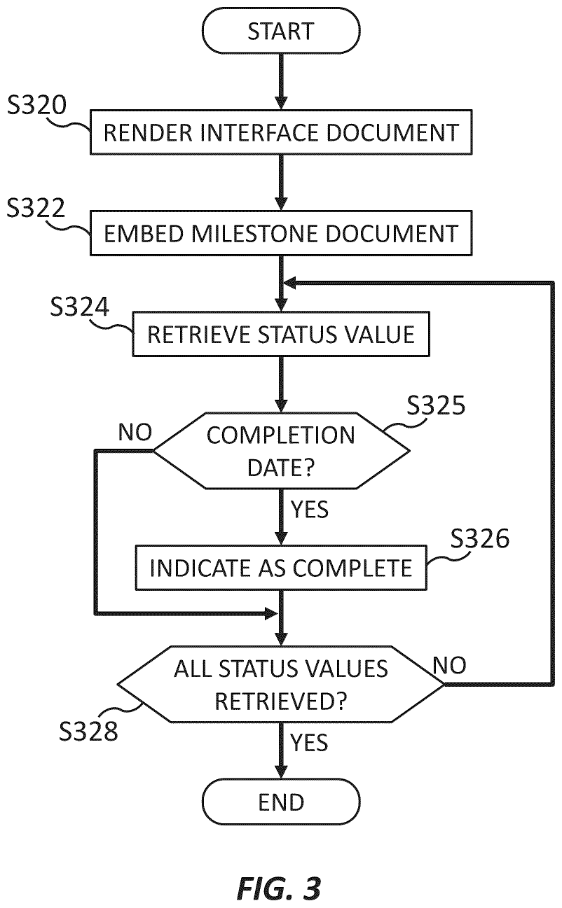

FIG. 3 is an operational flow for embedded milestone status, according to at least some embodiments of the present invention. The operational flow provides a method of embedded milestone status. In at least some embodiments, one or more operations of the method are executed by a controller of an apparatus including sections for performing certain operations, such as the controller and apparatus shown in FIG. 9, which will be explained hereinafter.

At S320, a rendering section of the controller renders an interface document. In at least some embodiments, the rendering section renders an interface document to cause a graphical interface to be displayed in accordance with appearance specifications for the graphical interface in the interface document. In at least some embodiments, the rendering section renders the interface document through a browser application on the apparatus. In at least some embodiments, the rendering section generates output signals to a display in communication with the apparatus in accordance with the appearance specifications in the interface document. In at least some embodiments, the rendering section accesses other documents and performs rendering in accordance with appearance specifications or other information within the other documents. In at least some embodiments, the interface document includes references to other specific documents including appearance specifications or information for completing an appearance specification in the interface document.

At S322, an embedding section of the controller embeds a milestone document into the interface document. In at least some embodiments, the embedding section embeds, into the interface document in response to rendering the interface document, a milestone document corresponding to a reference in the interface document and a user identity, the milestone document including a sequence of a plurality of milestone references. In at least some embodiments, the embedding section causes the rendering section to render the content of the milestone document as if the milestone document were a part of the interface document without modifying the content of the retrieved interface document. In at least some embodiments, the embedding section embeds the milestone document in response to the rendering section beginning the operation of rendering the interface document.

At S324, a retrieving section of the controller retrieves a status value. In at least some embodiments, as iterations of the operations of S324, S325, and S326 proceed, the retrieving section retrieves, through a network in response to embedding the milestone document, a plurality of status values, each status value among the plurality of status values corresponding to a milestone reference among the plurality of milestone references in the milestone document, each status value associated with a task of a workflow for adding a new access point to a radio access network, each workflow stored on a corresponding site database among a plurality of site databases. In at least some embodiments, the retrieving section retrieves the status value from a site database. In at least some embodiments, the retrieving section retrieves the status value through an API of the site database. In at least some embodiments, the retrieving section provides a user identifier during retrieval.

At S325, the controller or a section thereof determines whether the retrieved status value is a completion date. In at least some embodiments, the controller determines that the retrieved status value is a completion date where the retrieved status value is not simply a null value. In at least some embodiments, the controller determines that the retrieved status value is a completion date where the format of the retrieved status value fits a date format. If the controller determines that the retrieved status value is a completion date, then the operational flow proceeds to “as complete” indication at S326. If the controller determines that the retrieved status value is not a completion date, then the operational flow proceeds to retrieval determination at S328.

At S326, an indicating section of the controller indicates the milestone as complete. In at least some embodiments, as iterations of the operations of S324 and S326 proceed, the indicating section indicates, in the graphical interface, each milestone reference among the plurality of milestone references in the sequence that has been completed based on the plurality of status values. In at least some embodiments, the indicating section causes the rendering section to render, for each milestone reference in the sequence that has been completed, the corresponding completion date. In at least some embodiments, the indicating section indicates the status value within an area of the graphical interface for the corresponding milestone. In at least some embodiments, the indicating section causes the rendering section to generate output signals in accordance with the retrieved status value.

At S328, the controller or a section thereof determines whether all status values have been retrieved. In at least some embodiments, the controller determines whether a status value has been retrieved for each milestone reference in the milestone document. If the controller determines that status values remain to be retrieved, then the operational flow returns to status value retrieval at S324. If the controller determines that all status values have been retrieved, then the operational flow ends.

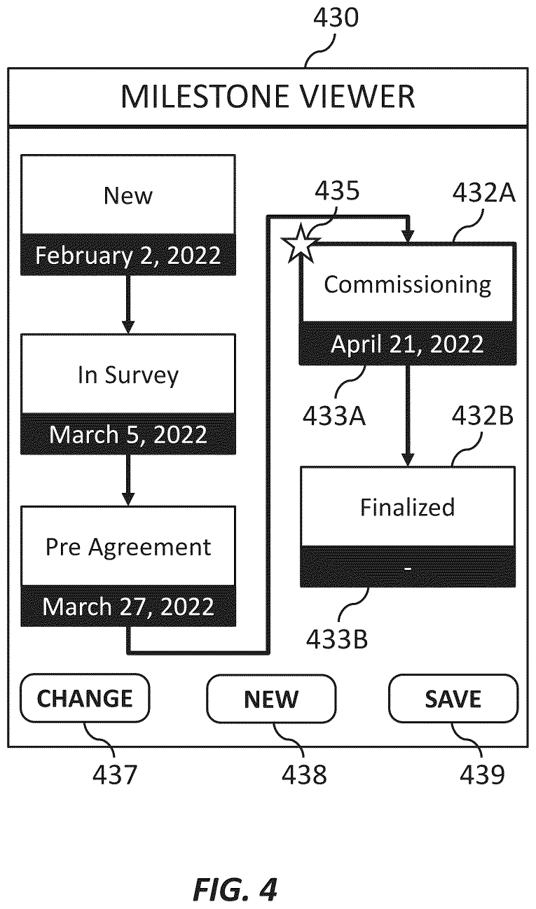

FIG. 4 is a graphical interface 430 with embedded milestone status, according to at least some embodiments of the present invention. In at least some embodiments, graphical interface 430 is presented by a display of an apparatus, such as display 110 of FIG. 1. In at least some embodiments, graphical interface 430 is configured to interact with user input from an input device of the apparatus, such as input device 112 of FIG. 1. Graphical interface 430 includes a plurality of milestone name fields, such as milestone name field 432A and milestone name field 432B, a plurality of corresponding status value fields, such as status value field 433A and status value field 433B, a latest milestone indicator 435, a change activation field 437, a new activation field 438, and a save activation field 439. In at least some embodiments, graphical interface 430 includes more or less fields than illustrated in FIG. 4, and arrangement of the fields in graphical interface 430 varies from the arrangement illustrated in FIG. 4. In at least some embodiments, the plurality of milestone name fields, the plurality of corresponding status value fields, latest milestone indicator 435, update activation field 437, edit activation field 438, and save activation field 439 are presented across multiple graphical user interfaces, such as tabs, windows, or other partitions.

Milestone name fields 432A and 432B each present a milestone name. In at least some embodiments, milestone name fields 432A and 432B each present a name associated with a milestone reference in the milestone document. In at least some embodiments, milestone name fields 432A and 432B are each a string of data included in the milestone document. In at least some embodiments, milestone name fields 432A and 432B are each a string of data included in a milestone template. In at least some embodiments, milestone name fields 432A and 432B are each a string of data retrieved from a site database along with the corresponding status value. Milestone name field 432A shows “Commissioning”, and milestone name field 432B shows “Finalized”.

Status value fields 433A and 433B each present the status value. In at least some embodiments, status value fields 433A and 433B each present the status value associated with a milestone reference in the milestone document. In at least some embodiments, status value fields 433A and 433B are each a string, integer, etc. of data retrieved from a site database. In at least some embodiments, each status value among the plurality of status values is at least one of a completion date or a null value. Status value field 433A shows “Apr. 21, 2022”. Together with corresponding milestone name field 432A, graphical interface 430 shows that the “Commissioning” milestone is complete as of Apr. 21, 2022. Latest milestone indicator 435 is positioned near milestone name field 432A to indicate that this is the latest milestone to be completed. Status value field 433B shows “−” in response to receiving a null value in response to a request to retrieve the status value. In response to status value field 433B changing to a date, latest milestone indicator 435 will be presented near milestone name field 432B.

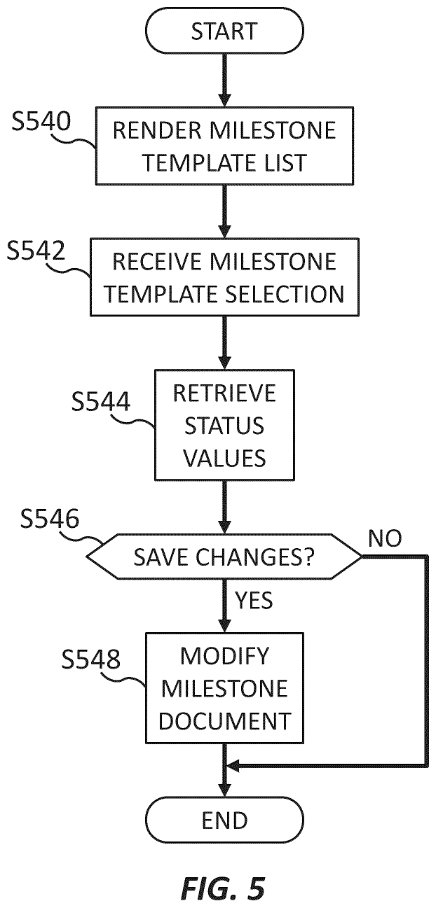

Change activation field 437 is an area of graphical interface 430 that performs an action upon interaction therewith. In at least some embodiments, change activation field 437 is presented in a form of a button, a checkbox, or in any other suitable form allowing the user to activate with an input device to cause the apparatus to perform the action. In at least some embodiments, change activation field 437 is configured to cause the apparatus to change the milestone template presented in graphical interface 430. In at least some embodiments, change activation field 437 is configured to cause the apparatus to perform the operation flow described hereinafter with respect to FIG. 5.

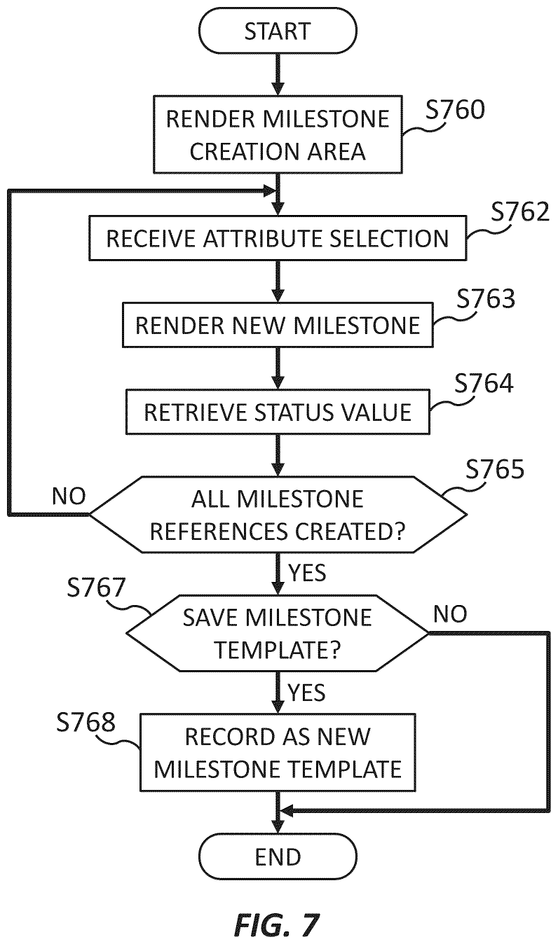

New activation field 438 is an area of graphical interface 430 that performs an action upon interaction therewith. In at least some embodiments, new activation field 438 is presented in a form of a button, a checkbox, or in any other suitable form allowing the user to activate with an input device to cause the apparatus to perform the action. In at least some embodiments, new activation field 438 is configured to cause the apparatus to present options for adding new milestones in graphical interface 430. In at least some embodiments, new activation field 438 is configured to cause the apparatus to perform the operation flow described hereinafter with respect to FIG. 7.

Save activation field 439 is an area of graphical interface 430 that performs an action upon interaction therewith. In at least some embodiments, save activation field 439 is presented in a form of a button, a checkbox, or in any other suitable form allowing the user to activate with an input device to cause the apparatus to perform the action. In at least some embodiments, save activation field 439 is configured to cause the apparatus to record modifications of graphical interface 430. In at least some embodiments, save activation field 439 is configured to cause the apparatus to modify the milestone document in accordance with the modifications of graphical interface 430. In at least some embodiments, save activation field 439 is configured to cause the apparatus to perform the operation at S767 described hereinafter with respect to FIG. 7.

In at least some embodiments, the graphical interface is any type of interface, such as a form, chart, table, etc., that enables a user to view and update status values, and to modify the milestones thereof. In at least some embodiments, the graphical interface includes additional fields, such as a milestone description field corresponding to each milestone name field, etc.

FIG. 5 is an operational flow for milestone template changing, according to at least some embodiments of the present invention. The operational flow provides a method of milestone template changing. In at least some embodiments, one or more operations of the method are executed by a controller of an apparatus including sections for performing certain operations, such as the controller and apparatus shown in FIG. 9, which will be explained hereinafter.

At S540, a rendering section or a sub-section thereof renders a milestone template list. In at least some embodiments, the rendering section renders, in response to receiving the instruction from the input device, the interface document to cause a list of milestone templates to be displayed in the graphical interface. In at least some embodiments, the instruction from the input device is transmitted in response to the input device activating a change activation field, such as change activation field 437 of FIG. 4.

At S542, the rendering section or a sub-section thereof receives a milestone template selection. In at least some embodiments, the rendering section receives a selection of a milestone template among the plurality of milestone templates in the list of milestone templates from the input device. In at least some embodiments, the selection is received from the input device in response to the input device activating a milestone template listing in the graphical interface. In at least some embodiments, the selection is received from the input device in response to the input device highlighting a milestone template listing in the graphical interface and then activating a select activation field in the graphical interface.

At S544, a retrieving section or a sub-section thereof retrieves status values of the selected milestone template. In at least some embodiments, the retrieving section retrieves, in response to receiving a selection of a milestone template among the plurality of milestone templates in the list of milestone templates from the input device, a plurality of status values, each status value among the plurality of status values corresponding to a milestone reference among the plurality of milestone references in the milestone template, each status value associated with a task of a workflow for adding a new access point to a radio access network, each workflow stored on a corresponding site database among the plurality of site databases. In at least some embodiments, the retrieving section retrieves each status value in a manner similar to status value retrieval operation S324 of FIG. 3.

At S546, the rendering section or a sub-section thereof determines whether to save the changes of the milestone template. In at least some embodiments, the rendering section awaits activation of a save activation field of the graphical interface, such as save activation field 439 of FIG. 4. In at least some embodiments, the rendering section detects activation of the save activation field in response to activation by the input device. If the rendering section determines to save the changes of the milestone template, then the operational flow proceeds to milestone document modification at S548. If the rendering section determines not to save the changes of the milestone template, then the operational flow ends.

At S548, the rendering section or a sub-section thereof modifies the milestone document. In at least some embodiments, the rendering section modifies the milestone document by replacing the milestone references with the plurality of milestone references in the milestone template. In at least some embodiments, the rendering section overwrites the milestone document, and causes the embedding section to push the modified milestone document to a milestone server, such as milestone server 116 of FIG. 1.

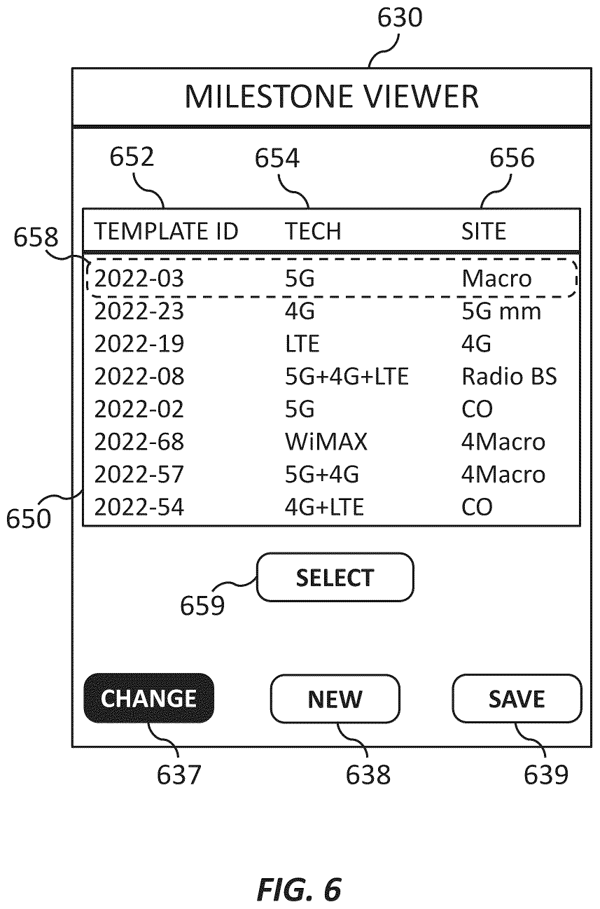

FIG. 6 is a graphical interface 630 during milestone template changing, according to at least some embodiments of the present invention. In at least some embodiments, graphical interface 630 is presented by a display of an apparatus, such as display 110 of FIG. 1. In at least some embodiments, graphical interface 630 is configured to interact with user input from an input device of the apparatus, such as input device 112 of FIG. 1. Graphical interface 630 includes a list of milestone templates 650, a select activation field 659, a change activation field 637, a new activation field 638, and a save activation field 639. In at least some embodiments, graphical interface 630 includes more or less fields than illustrated in FIG. 6, and arrangement of the fields in graphical interface 630 varies from the arrangement illustrated in FIG. 6. In at least some embodiments, list of milestone templates 650, the plurality of milestone template listings, select activation field 659, change activation field 637, new activation field 638, and save activation field 639 are presented across multiple graphical user interfaces, such as tabs, windows, or other partitions.

Change activation field 637, new activation field 638, and save activation field 639 are substantially similar in structure and function to change activation field 437, edit activation field 438, and save activation field 439 of FIG. 4, respectively, except as expressly distinguished. Change activation field 637 has been activated by the input device to cause the apparatus to display list of milestone templates 650 in the graphical interface.

List of milestone templates 650 includes a plurality of milestone template listings, such as milestone template listing 658, each listing showing a plurality of labels, such as template identifier 652, technology type 654, and site type 656. Milestone template listing 658 shows a template identifier of “2022-03”, which uniquely identifies milestone template listing 658 from other milestone template listings. Milestone template listing 658 shows a technology type of “5G”, which shows what type of communication technology the milestone is intended to be used for. Milestone template listing 658 shows a site type of “Macro”, which shows what type of site the milestone is intended to be used for. Milestone template listing 658 is currently highlighted. In at least some embodiments, milestone template listing 658 is highlighted in response to an input device activating the area of milestone template listing 658 in graphical interface 630.

Select activation field 659 is an area of graphical interface 630 that performs an action upon interaction therewith. In at least some embodiments, select activation field 659 is presented in a form of a button, a checkbox, or in any other suitable form allowing the user to activate with an input device to cause the apparatus to perform the action. In at least some embodiments, select activation field 659 is configured to cause the apparatus to render milestone references of a highlighted milestone template listing. In at least some embodiments, select activation field 659 is configured to cause the apparatus to modify the milestone document in accordance with the highlighted milestone template listing. In at least some embodiments, select activation field 659 is configured to cause the apparatus to perform status value retrieval operation S544 of FIG. 5.

FIG. 7 is an operational flow for milestone template creation, according to at least some embodiments of the present invention. The operational flow provides a method of milestone template creation. In at least some embodiments, one or more operations of the method are executed by a controller of an apparatus including sections for performing certain operations, such as the controller and apparatus shown in FIG. 9, which will be explained hereinafter.

At S760, a rendering section or a sub-section thereof renders a milestone creation area. In at least some embodiments, the rendering section renders, in response to receiving an instruction from the input device, the interface document to cause a milestone creation area to be displayed in the graphical interface. In at least some embodiments, the rendering section causes the apparatus to display a blank milestone and a plurality of milestone attribute fields. In at least some embodiments, the rendering section renders the milestone creation area in response to activation, by an input device, of a new activation field, such as new activation field 638 of FIG. 6.

At S762, the rendering section or a sub-section thereof receives a selection of attributes. In at least some embodiments, the rendering section receives, from an input device for a new milestone reference, a selection of attributes including a milestone identifier, a relative position among milestone references in the milestone template, and a task identifier associated with a first task of a first workflow stored on a first site database among the plurality of site databases. In at least some embodiments, the rendering section receives the selection of attributes in response to an input device entering strings and values for the attributes in the graphical interface.

At S763, the rendering section or a sub-section thereof renders the new milestone. In at least some embodiments, the rendering section rendering the interface document to cause the new milestone reference to be displayed in the graphical interface. In at least some embodiments, the rendering section causes the graphical interface to show relevant attributes in the blank milestone.

At S764, a retrieving section or a sub-section thereof retrieves a status value of the new milestone. In at least some embodiments, the retrieving section retrieves a first status value among the plurality of status values from the first site database among the plurality of site databases. In at least some embodiments, the retrieving section retrieves the status value in a manner similar to status value retrieval operation S324 of FIG. 3.

At S765, the rendering section or a sub-section thereof determines whether all milestone references have been created. In at least some embodiments, the rendering section determines that tall milestone references have been created in response to deactivation, by an input device, of the new activation field. If the rendering section determines that more milestone references will be created, then the operational flow returns to attribute selection reception at S762. If the rendering section determines that all milestone references have been created, then the operational flow proceeds to milestone template saving at S767.

At S767, the rendering section or a sub-section thereof determines whether to save the milestone template. In at least some embodiments, the rendering section awaits activation of a save activation field of the graphical interface, such as save activation field 439 of FIG. 4. In at least some embodiments, the rendering section detects activation of the save activation field in response to activation by the input device. If the rendering section determines to save the milestone template, then the operational flow proceeds to milestone template recording at S768. If the rendering section determines not to save the milestone template, then the operational flow ends.

At S768, the rendering section or a sub-section thereof records the milestone template as a new milestone template. In at least some embodiments, the rendering section recording the new milestone reference as a new milestone template to a milestone database. In at least some embodiments, the rendering section causes the embedding section to push the new milestone template to a milestone server, such as milestone server 116 of FIG. 1. In at least some embodiments, the rendering section records the new milestone reference along with a template identifier, a technology type, and a site type.

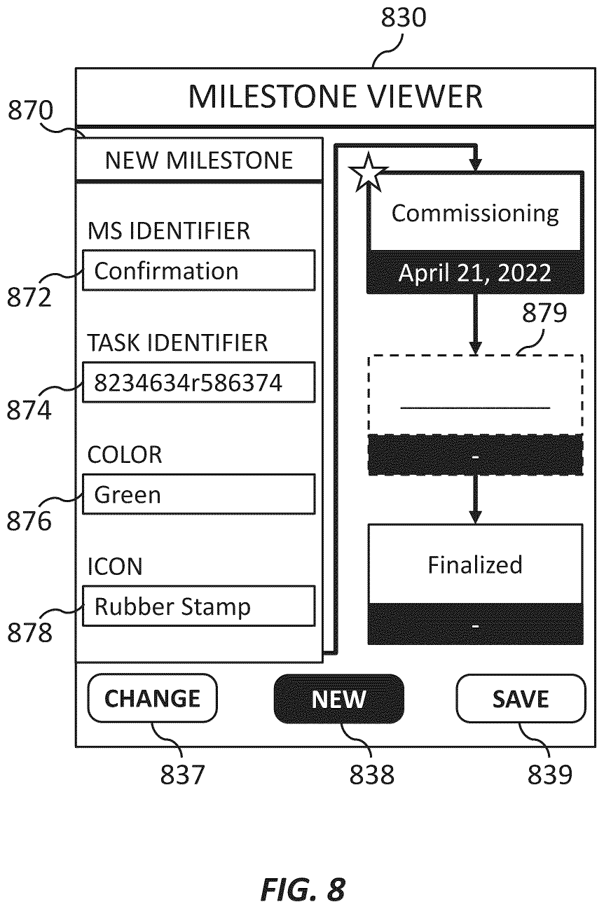

FIG. 8 is a graphical interface 830 during milestone template creation, according to at least some embodiments of the present invention. In at least some embodiments, graphical interface 830 is presented by a display of an apparatus, such as display 110 of FIG. 1. In at least some embodiments, graphical interface 830 is configured to interact with user input from an input device of the apparatus, such as input device 112 of FIG. 1. Graphical interface 830 includes a milestone creation area 870, a blank milestone 879, a change activation field 837, a new activation field 838, and a save activation field 839. In at least some embodiments, graphical interface 830 includes more or less fields than illustrated in FIG. 8, and arrangement of the fields in graphical interface 830 varies from the arrangement illustrated in FIG. 8. In at least some embodiments, milestone creation area 870, blank milestone 879, change activation field 837, new activation field 838, and save activation field 839 are presented across multiple graphical user interfaces, such as tabs, windows, or other partitions.

Change activation field 837, new activation field 838, and save activation field 839 are substantially similar in structure and function to change activation field 437, edit activation field 438, and save activation field 439 of FIG. 4, respectively, except as expressly distinguished. New activation field 838 has been activated by the input device to cause the apparatus to display milestone creation area 870 and blank milestone 879 in the graphical interface.

Milestone creation area 870 includes a plurality of milestone attribute fields, such as milestone identifier field 872, milestone task identifier 874, milestone color 876, and milestone icon 878. Milestone creation area 870 shows a milestone identifier of “Confirmation”, which identifies the milestone within the milestone template. Milestone creation area 870 shows a task identifier of “8234634r586374”, which uniquely identifies a task of a workflow of a site database. Milestone creation area 870 shows a color of “Green” and an icon of “Rubber Stamp”, which are used to visually distinguish from other milestones in graphical interface 830.

FIG. 9 is a block diagram of a hardware configuration for embedded milestone status, according to at least some embodiments of the present invention.

The exemplary hardware configuration includes apparatus 900, which interacts with display 907 and input device 908, and communicates with network 918. In at least some embodiments, apparatus 900 is a computer or other computing device that receives input or commands from input device 908. In at least some embodiments, apparatus 900 is integrated with input device 908. In at least some embodiments, apparatus 900 is a computer system that executes computer-readable instructions to perform operations for embedded milestone status.

Apparatus 900 includes a controller 902, a storage unit 904, an input/output interface 906, and a communication interface 909. In at least some embodiments, controller 902 includes a processor or programmable circuitry executing instructions to cause the processor or programmable circuitry to perform operations according to the instructions. In at least some embodiments, controller 902 includes analog or digital programmable circuitry, or any combination thereof. In at least some embodiments, controller 902 includes physically separated storage or circuitry that interacts through communication. In at least some embodiments, storage unit 904 includes a non-volatile computer-readable medium capable of storing executable and non-executable data for access by controller 902 during execution of the instructions. Communication interface 909 transmits and receives data from network 918. Input/output interface 906 connects to various input and output units, such as input device 908, via a parallel port, a serial port, a keyboard port, a mouse port, a monitor port, and the like to accept commands and present information. In some embodiments, storage unit 904 is external from apparatus 900.

Controller 902 includes rendering section 980, embedding section 982, retrieving section 984, and indicating section 986. Storage unit 904 includes document cache 990, rendering parameters 992, and milestone attributes 994.

Rendering section 980 is the circuitry or instructions of controller 902 configured to render interface documents and associated information. In at least some embodiments, rendering section 980 is configured to render an interface document to cause a graphical interface to be displayed in accordance with appearance specifications for the graphical interface in the interface document. In at least some embodiments, rendering section 980 utilizes information in storage unit 904, such as document cache 990 and rendering parameters 992. In at least some embodiments, rendering section 980 includes sub-sections for performing additional functions, as described in the foregoing flow charts. In at least some embodiments, such sub-sections is referred to by a name associated with a corresponding function.

Embedding section 982 is the circuitry or instructions of controller 902 configured to embed documents for rendering. In at least some embodiments, embedding section 982 is configured to embed, into the interface document in response to rendering the interface document, a milestone document corresponding to a reference in the interface document and a user identity, the milestone document including a sequence of a plurality of milestone references. In at least some embodiments, embedding section 982 utilizes information in storage unit 904, such as document cache 990. In at least some embodiments, embedding section 982 includes sub-sections for performing additional functions, as described in the foregoing flow charts. In at least some embodiments, such sub-sections is referred to by a name associated with a corresponding function.

Retrieving section 984 is the circuitry or instructions of controller 902 configured to retrieve status values and associated information. In at least some embodiments, retrieving section 984 is configured to retrieve, through a network in response to embedding the milestone document, a plurality of status values, each status value among the plurality of status values corresponding to a milestone reference among the plurality of milestone references in the milestone document, each status value associated with a task of a workflow for adding a new access point to a radio access network, each workflow stored on a corresponding site database among a plurality of site databases. In at least some embodiments, retrieving section 984 utilizes information from storage unit 904, such as document cache 990, and records information to storage unit 904, such as milestone attributes 994. In at least some embodiments, retrieving section 984 includes sub-sections for performing additional functions, as described in the foregoing flow charts. In at least some embodiments, such sub-sections is referred to by a name associated with a corresponding function.

Indicating section 986 is the circuitry or instructions of controller 902 configured to indicate completed milestones. In at least some embodiments, indicating section 986 is configured to indicate, in the graphical interface, each milestone reference among the plurality of milestone references in the sequence that has been completed based on the plurality of status values. In at least some embodiments, indicating section 986 utilizes information from storage unit 904, document cache 990. In at least some embodiments, retrieving section 984 includes sub-sections for performing additional functions, as described in the foregoing flow charts. In at least some embodiments, such sub-sections is referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

According to at least some embodiments of the present invention, embedded milestone status is presented by rendering an interface document to cause a graphical interface to be displayed in accordance with appearance specifications for the graphical interface in the interface document, embedding, into the interface document in response to rendering the interface document, a milestone document corresponding to a reference in the interface document and a user identity, the milestone document including a sequence of a plurality of milestone references, retrieving, through a network in response to embedding the milestone document, a plurality of status values, each status value among the plurality of status values corresponding to a milestone reference among the plurality of milestone references in the milestone document, each status value associated with a task of a workflow for adding a new access point to a radio access network, each workflow stored on a corresponding site database among a plurality of site databases, and indicating, in the graphical interface, each milestone reference among the plurality of milestone references in the sequence that has been completed based on the plurality of status values.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a processor to cause the processor to perform operations comprising:
rendering an interface document to cause a graphical interface to be displayed in accordance with appearance specifications for the graphical interface in the interface document;
embedding, into the interface document in response to rendering the interface document, a milestone document corresponding to a reference in the interface document and a user identity, the milestone document including a sequence of a plurality of milestone references;
retrieving, through a network in response to embedding the milestone document, a plurality of status values, each status value among the plurality of status values corresponding to a milestone reference among the plurality of milestone references in the milestone document, each status value associated with a task of a workflow for adding a new access point to a radio access network, each workflow stored on a corresponding site database among a plurality of site databases; and
indicating, in the graphical interface, each milestone reference among the plurality of milestone references in the sequence that has been completed based on the plurality of status values.

2. The computer-readable medium of claim 1, wherein each status value among the plurality of status values is at least one of a completion date or a null value.

3. The computer-readable medium of claim 2, wherein the indicating operation further includes:
rendering, for each milestone reference in the sequence that has been completed, the corresponding completion date.

4. The computer-readable medium of claim 1, wherein the operations further comprise:
rendering, in response to receiving the instruction from the input device, the interface document to cause a list of milestone templates to be displayed in the graphical interface; and
retrieving, in response to receiving a selection of a milestone template among the plurality of milestone templates in the list of milestone templates from the input device, a plurality of status values, each status value among the plurality of status values corresponding to a milestone reference among the plurality of milestone references in the milestone template, each status value associated with a task of a workflow for adding a new access point to a radio access network, each workflow stored on a corresponding site database among the plurality of site databases.

5. The computer-readable medium of claim 4, wherein the operations further comprise:
modifying the milestone document by replacing the milestone references with the plurality of milestone references in the milestone template.

6. The computer-readable medium of claim 1, wherein the operations further comprise:
rendering, in response to receiving the instruction from the input device, the interface document to cause a milestone creation area to be displayed in the graphical interface;
receiving, from an input device for a new milestone reference, a selection of attributes including a milestone identifier, a relative position among milestone references in the milestone template, and a task identifier associated with a first task of a first workflow stored on a first site database among the plurality of site databases; and
rendering the interface document to cause the new milestone reference to be displayed in the graphical interface.

7. The computer-readable medium of claim 6, wherein the operations further comprise:
retrieving a first status value among the plurality of status values from the first site database among the plurality of site databases.

8. The computer-readable medium of claim 6, wherein the operations further comprise:
recording the new milestone reference as a new milestone template to a milestone database.

9. A method comprising:
rendering an interface document to cause a graphical interface to be displayed in accordance with appearance specifications for the graphical interface in the interface document;
embedding, into the interface document in response to rendering the interface document, a milestone document corresponding to a reference in the interface document and a user identity, the milestone document including a sequence of a plurality of milestone references;
retrieving, through a network in response to embedding the milestone document, a plurality of status values, each status value among the plurality of status values corresponding to a milestone reference among the plurality of milestone references in the milestone document, each status value associated with a task of a workflow for adding a new access point to a radio access network, each workflow stored on a corresponding site database among a plurality of site databases; and
indicating, in the graphical interface, each milestone reference among the plurality of milestone references in the sequence that has been completed based on the plurality of status values.

10. The method of claim 9, wherein each status value among the plurality of status values is at least one of a completion date or a null value.

11. The method of claim 10, wherein the indicating operation further includes:
rendering, for each milestone reference in the sequence that has been completed, the corresponding completion date.

12. The method of claim 9, further comprising:
rendering, in response to receiving the instruction from the input device, the interface document to cause a list of milestone templates to be displayed in the graphical interface; and
retrieving, in response to receiving a selection of a milestone template among the plurality of milestone templates in the list of milestone templates from the input device, a plurality of status values, each status value among the plurality of status values corresponding to a milestone reference among the plurality of milestone references in the milestone template, each status value associated with a task of a workflow for adding a new access point to a radio access network, each workflow stored on a corresponding site database among the plurality of site databases.

13. The method of claim 12, further comprising:
modifying the milestone document by replacing the milestone references with the plurality of milestone references in the milestone template.

14. The method of claim 9, further comprising:
rendering, in response to receiving the instruction from the input device, the interface document to cause a milestone creation area to be displayed in the graphical interface;
receiving, from an input device for a new milestone reference, a selection of attributes including a milestone identifier, a relative position among milestone references in the milestone template, and a task identifier associated with a first task of a first workflow stored on a first site database among the plurality of site databases; and
rendering the interface document to cause the new milestone reference to be displayed in the graphical interface.

15. The method of claim 14, further comprising:
retrieving a first status value among the plurality of status values from the first site database among the plurality of site databases.

16. The method of claim 14, further comprising:
recording the new milestone reference as a new milestone template to a milestone database.

17. An apparatus comprising:
a controller including circuitry configured to:
render an interface document to cause a graphical interface to be displayed in accordance with appearance specifications for the graphical interface in the interface document;
embed, into the interface document in response to rendering the interface document, a milestone document corresponding to a reference in the interface document and a user identity, the milestone document including a sequence of a plurality of milestone references;
retrieve, through a network in response to embedding the milestone document, a plurality of status values, each status value among the plurality of status values corresponding to a milestone reference among the plurality of milestone references in the milestone document, each status value associated with a task of a workflow for adding a new access point to a radio access network, each workflow stored on a corresponding site database among a plurality of site databases; and
indicate, in the graphical interface, each milestone reference among the plurality of milestone references in the sequence that has been completed based on the plurality of status values.

18. The method of claim 17, wherein each status value among the plurality of status values is at least one of a completion date or a null value.

19. The method of claim 18, wherein the controller is further configured to:
render, for each milestone reference in the sequence that has been completed, the corresponding completion date.

20. The method of claim 17, wherein the controller is further configured to:
render, in response to receiving the instruction from the input device, the interface document to cause a list of milestone templates to be displayed in the graphical interface; and
retrieve, in response to receiving a selection of a milestone template among the plurality of milestone templates in the list of milestone templates from the input device, a plurality of status values, each status value among the plurality of status values corresponding to a milestone reference among the plurality of milestone references in the milestone template, each status value associated with a task of a workflow for adding a new access point to a radio access network, each workflow stored on a corresponding site database among the plurality of site databases.
